(19) United States
(12) Patent Application Publication
(10) Pub. No.: US 2015/0019307 A1
(43) Pub. Date: Jan. 15, 2015

(54) MOBILE ADVERTISING

(71) Applicant: Aquto Corporation, Boston, MA (US)

(72) Inventors: Nicolas Girard, Boston, MA (US); Scott D. Klein, Hingham, MA (US)

(73) Assignee: Aquto Corporation, Boston, MA (US)

(21) Appl. No.: 14/325,588

(22) Filed: Jul. 8, 2014

Related U.S. Application Data
(60) Provisional application No. 61/845,738, filed on Jul. 12, 2013.

(51) Int. Cl. G06Q 30/02

(52) U.S. Cl. CPC G06Q 30/0267; G06Q 30/0207
USPC 705/14.12; 705/14.1; 705/14.64

(57) ABSTRACT

Methods, systems, and apparatus, including computer programs encoded on computer storage media, for mobile advertising. One of the methods includes receiving from a user of a mobile device an indication of a response of the user to a presentation of content on the mobile device. The method includes in connection with the presentation of the content or the receipt of the indication of a response of the user, receiving information from a mobile carrier about the user. The method also includes based on the response of the user and the information about the user, generating an offer to be presented to the user after the content has been presented.

### CROSS-REFERENCE TO RELATED APPLICATIONS

This application claims priority to U.S. Provisional Application Ser. No. 61/845,738, filed on Jul. 12, 2013, entitled “MOBILE ADVERTISING,” and relates to information described in U.S. application Ser. No. 13/893,744, filed on May 14, 2013, entitled “CHARGING AND BILLING FOR CONTENT, SERVICES, AND ACCESS,” and U.S. application Ser. No. 13/893,870, filed on May 14, 2013, entitled “ADVERTISER SUPPORTED BANDWIDTH PLATFORM”, which are incorporated here by reference in their entirety.

### BACKGROUND

With the advent of mobile devices more powerful than the workstations of just a few years ago and the introduction of cellular technologies faster than their fixed line counterparts, mobile computing has become a popular way to consume content, contributing to large amounts of data being carried over cellular networks, and growing at an fast pace. Wireless network capacity is limited by the capacity of the shared wireless medium in a region as a result of a finite set of available frequencies and the laws of physics that limit the number of bits than can be carried per hertz. Based on these factors, wireless network capacity is expected quickly to exceed the supply.

Mobile operators (i.e., operators of wireless networks) are spending capital acquiring the rights to spectrum frequencies and building out network infrastructure to carry the additional traffic. To pay for these improvements, the telecom industry is switching from unlimited pricing (in which the customer receives unlimited service for a fixed monthly price, for example) to tier pricing (in which charges are based on the amount of bandwidth used). But tier pricing is not a satisfying and cost-effective solution as it restricts mobile, on-the-go consumption and often results in overage when subscribers hit their data limits, i.e., consume more than their data allotment. Mobile operators want to increase their revenues. Subscribers want more mobile broadband at no additional cost while mobile operators need incremental revenues to account for the added load on their networks and continue investing in their infrastructure. At the same time, advertisers and other content providers want to increase user engagement with their advertisements and content.

### SUMMARY

In general, one innovative aspect of the subject matter described in this specification can be embodied in methods that include the actions of receiving a request associated with the presentation of an advertisement associated with an advertisement campaign to a user. The methods also include the actions of determining that the user is eligible for an offer of a reward. The methods also include the actions of sending the offer for the reward to the user in return for the user performing an incentivized action. The methods also include the actions of receiving an indication that the user has earned the reward. The methods also include the actions of providing the reward.

In general, one innovative aspect of the subject matter described in this specification can be embodied in methods that include the actions of receiving from a user of a mobile device an indication of a response of the user to a presentation of content on the mobile device. The methods also include the actions of in connection with the presentation of the content or the receipt of the indication of a response of the user, receiving information from a mobile carrier about the user. The methods also include the actions of based on the response of the user and the information about the user, generating an offer to be presented to the user after the content has been presented.

Other embodiments of this aspect include corresponding computer systems, apparatus, and computer programs recorded on one or more computer storage devices, each configured to perform the actions of the methods. A system of one or more computers can be configured to perform particular actions by virtue of having software, firmware, hardware, or a combination of them installed on the system that in operation causes or cause the system to perform the actions. One or more computer programs can be configured to perform particular actions by virtue of including instructions that, when executed by data processing apparatus, cause the apparatus to perform the actions.

1. The foregoing and other embodiments can each optionally include one or more of the following features, alone or in combination. A method may include the actions of determining a size of the reward based on information about the user. The information about the user may include an indicator of the user's response to previous offers. A method may include the actions of determining a size of the reward based on a comparison of a target conversion rate to a current conversion rate. A method may include the actions of determining a size of the reward based on a comparison of an amount previously awarded during the advertising campaign to a remaining budget. A method may include the actions of determining a size of the reward based on a current time. A method may include the actions of determining a size of the reward based on a number of days remaining in the advertising campaign and a budget remaining in the advertising campaign. Receiving an indication that the user has earned the reward may include the actions of receiving a code from the user and verifying that the code is valid. Verifying that the code is valid may include determining that an advertiser has digitally signed the code using a public key. The reward may include wireless network credit. Determining that the user is eligible for the reward may include determining that the user has an account with an operator that will provide wireless network credit. Determining that the user is eligible for the reward may include determining that the user does not have an unlimited wireless data plan. Determining that the user is eligible for the reward may include determining the remaining data usage the user has for a billing period. Providing the reward may include transmitting data to a remote server to cause the redemption of wireless network credit in the account by a wireless network operator server. The wireless network credit may be redeemed as a discount on the fee for an existing wireless account. The credits may be accumulated before being applied to the user's account. The credits may be applied to the user's account periodically. The user may be asked to opt into the service prior to receiving an offer. The user may be asked to opt into a service prior to being determined to be eligible for an offer. The offer may be a reward in exchange for the user's e-mail address. The offer may be a reward in exchange for the user downloading an application. The offer may be a reward in exchange for the user visiting a web site. The offer may be a reward in exchange for the user making a purchase. A mobile data account associated with the user's account may not be charged for the presentation of the advertisement. A credit for the data associated with the presentation of the advertisement may be credited to the mobile data account associated with the user's account. A mobile data account associated with the user's account may not be charged for data used in performing the incentivized action. A credit for the data associated with the performance of the incentivized action may be credited to the mobile data account associated with the user's account. The incentivized action may include watching a video. The incentivized action may include filling out a survey. The incentivized action may include providing an e-mail address. The incentivized action may include making a purchase in a mobile application. The incentivized action may include endorsing a product. The incentivized action may include purchasing a good or service. The incentivized action may include using a feature of an application. The incentivized action may include reaching a milestone in a game. The reward may include a gift certificate. The reward may include a store credit. The reward may include credit toward specific content. The reward may include early access to content. The reward may include access to pay per view content. The method may include the actions of receiving the information from the mobile carrier about the user between the time when the user has indicated a response to the presentation of the content and the time when the offer is presented. The information may be received from the mobile carrier about the user by sending queries to the mobile carrier and receiving replies to the queries that are based on information stored by the mobile carrier. The indication of the response of the user to the presentation of the content may be received by a party that is not the mobile carrier. The indication of the response of the user to the presentation of the content may include an action performed by the user in a user interface of the mobile device. Generating the offer may include selecting an offer provided by a party who wishes to incentivize an action by the user. Generating the offer may include selecting the offer as one that is likely to successfully incentivize an action by the user. The offer may include value to be provided to the user in exchange for an action of the user. The value may include services of a mobile carrier. The value may include nonmonetary rewards. A method may include the action of presenting the offer to the user on an advertiser's landing page. The offer may be generated based on information about a budget of a promotional campaign associated with the offer.

Particular embodiments of the invention can be implemented to realize none, one or more of the following advantages. Some implementations may facilitate user engagement by offering incentives to users of a system. Some implementations may facilitate the leverage of mobile data as a form of currency. Some implementations may allow users to consume more mobile content without spending more money. Some implementations may increase subscriber loyalty to operators of wireless networks to which they subscribe and reduce subscriber churn. Some implementations may expand and protect market share for mobile operators offering mobile data plans. Some implementations may increase mobile operator revenue by allowing advertisers to subsidize consumer's mobile data consumption. Some implementations may enhance user engagement with content items. Some implementations may increase advertising conversion rates.

The details of one or more embodiments of the invention are set forth in the accompanying drawings and the description below. Other features, aspects, and advantages of the invention will become apparent from the description, the drawings, and the claims.

### BRIEF DESCRIPTION OF THE DRAWINGS

FIG. 1 is an example of a user interface flow.

FIG. 2 is a conceptual representation of a logical architecture for a mobile value exchange.

FIG. 3 is a sequence diagram illustrating an example of an advertisement conversion.

FIG. 4 is a flowchart of an example of a process for determining if a user is eligible for a reward.

FIG. 5 is a flow chart of an example of a process for offer redemption.

FIG. 6 is an example of user interface flow.

FIG. 7 is a sequence diagram illustrating an example of a process of presenting an offer for a reward for downloading a mobile app.

FIGS. 8A-B are examples of the presentation of different offers.

FIG. 9 is a conceptual representation of HTTP header expansion.

FIG. 10 is a conceptual representation of tracking and identifying users.

FIGS. 11A-C are sequence diagrams illustrating an example of third-party inventory retargeting.

FIG. 12 is a sequence diagram illustrating an example of a process for using cookies to track eligibility.

FIG. 13 shows an example of a generic computer device 1400 and a generic mobile computing device

### DETAILED DESCRIPTION

People are continually using more wireless bandwidth. Movies, music, television, and games are all sent wirelessly to users of mobile devices. In response, many mobile service providers have limited the amount of bandwidth that a user may use during a particular time period. For example, some users may be restricted to 1, 2, or 5 gigabytes of data per month. Additional bandwidth usage may require the payment of additional fees. Faced with the charges, users must either pay for the additional bandwidth or reduce their bandwidth consumption below their personal optimal level. Because mobile data is limit, this enables the use of mobile data as a form of currency.

At the same time, advertisers and other content providers want to increase user engagement with their advertisements and content. Advertising has become an important way of monetizing websites and mobile applications. However, users generally have a negative response to intrusive advertising. Historically, online display advertisements or “banners” were very popular. Advertisers paid large amounts to website publishers for these advertisements to be presented to users. Each time an advertisement is presented to a user is referred to as an impression. Advertisers are charged by the number of impressions achieved.

One way to view the effectiveness of an advertising impression is whether the user takes an action (such as clicking to view more information) in response to the impression. As the number of advertisements increased, the effectiveness of the advertising impressions has decreased. For example, for every 1,000,000 ad impressions, less than 2000 may be clicked or otherwise selected. The ratio of the number of times an advertisement is clicked to the number of impressions is referred to as the Click-Through-Rate. In our example, of the 2000 advertisements that are clicked, less than 20 may result in a conversion. In general, a conversion is the successful completion of a specific action that the advertiser has solicited, for example, the user buys a product, subscribes to a mailing list, watches a video, etc. The ratio of the number of times an impression of an advertisement results in a conversion to the number of impressions is referred to as the conversion rate.

Generally, the price for advertisement placement is the cost per mille (CPM) which is calculated based on a cost of a thousand impressions of the advertisement. The decrease in the effectiveness of the advertisement has caused the CPM to similarly decrease. An alternative pricing structure includes paying for each completed action. With cost per action (CPA) pricing the advertiser only pays the publisher when the consumer takes the specified action.

The recent increase in mobile applications and social games has provided an opportunity to create an advertising model with an incentive system that rewards customers for committing their attention or data to an advertising experience. For advertisers, rewarding consumers causes the consumers to focus on a specified action, which in turn leads to improved user engagement. The improved engagement can result in better conversion rates, which in turn improves the economics of advertising.

The purpose of the Mobile Value Exchange Platform (MVEP) that we describe here is to create value and drive efficiency by improving user engagement by displaying a reward offer when the call-to-action is presented to the user. This type of engagement can result in dramatically improved Conversion Rate, in some cases up to 10 times better than the industry average of 1%.

Using the system that we describe here, in exchange for improving conversion rate for the advertiser, the advertising network will be able to charge more, for example, a $3 CPM premium in exchange for a 3% conversion rate. The advertiser will be able to pay, for example, $8 CPM for 10,000,000 ad impressions, which based on the industry standard CTR (click through rate) results in 50,000 clicks. In some implementations, the CTR is not impacted by the MVEP platform. With a Conversion Rate of 3%, those 50,000 clicks will result in 1500 conversions or an effective $53 cost per conversion to the advertise, a 47% improvement in efficiency. The difference between the original advertising campaign money spent (i.e., the spend) and the MVEP enabled campaign can be used to pay for the rewards and the balance can be split between the ad network upselling the advertiser for the capability, and the operator of the MVEP platform selling the capability to the ad network.

The MVEP platform described here can be leveraged to incentivize many different types of actions desired the advertiser. As used herein actions refer to any activity that a user can perform. Incentivized actions refer to any activity that a user can perform that a content provider desires to encourage. For example, as in-app purchases (unlocking features, buying digital content, etc.) become a popular form of monetization for mobile applications (a so called “freemium” model), incentivizing those in-app transactions is valuable. The mobile application itself can be distributed for free and the publisher monetizes the application by selling incremental features, functionality, and digital and virtual goods, for example. This approach becomes more viable when the cost of getting the users to buy the features, functionality, or goods, is lowered.

For instance, the base or “free” version of a game could have ten levels of gameplay available for free with advanced levels that can be purchased and unlocked for a fee. A music app could make the first thirty seconds of a song available and the rest of the song would need to be purchased from within the app. Similarly, as in-app advertising becomes another popular form of monetization for the mobile ecosystem, time spent in the application by the user is a critical measure for selling advertising—the more the user spends time interacting with the app, the more ads an app publisher can display, which directly increases their revenue from the advertisers. The MVEP platform can be used to incentivize specific in-app milestones and measures of user engagement, such as launching the app daily, reaching a specific game level or game achievement, performing specific actions or using specific features of the apps (for instance opt-in for location sharing, signing up for the trial of a paid service, etc.). Likewise, specific user behavior can be valuable to the advertiser and worth incentivizing; for instance, the action of asking for support inside a mobile app instead of calling an expensive call center, the action of booking a flight or a hotel room using the company's mobile application instead of calling the free concierge service or using the website, the action of paying using a specific payment provider such as direct carrier billing instead of an expensive payment gateway, etc.

Mobile commerce (m-commerce) transactions can also be incentivized by the MVEP platform. In some cases, incentives can be applied to get consumers to reach a certain cart price level or upsell specific items; for example, the user may be advertised to “get rewarded with 1 GB for your tablet when you book at least one hotel room on top of your airline reservation”.

The MVEP platform can also be leveraged to incentivize social transactions, from referring friends and family to sponsored products, collecting rewards to share insights on social networks, to “tweeting”, “liking” and “pinning” sponsor pages on social services such as TWITTER, FACEBOOK and PINTEREST.

The actions and conversion types presented above can also be combined; for instance, an advertiser could decide to promote the installation of a mobile application and reward the user only when an in-app milestone is reached, for instance reaching level 3 in a game, reading at least 10 articles in a news app or making the first in-app purchase.

For the actions and conversion above, the mechanisms described for the in-flight ad and app offer display conversion apply. In some cases, the execution of the code responsible for determining eligibility, rendering the offer and converting the offer can be packaged differently, for instance as a SDK (Software Development Kit) or a shared library that gets compiles with native code. That is, instead of a piece of web technologies code (such as HTML5 and JAVASCRIPT) that gets triggered dynamically when a web page is rendered, a native application would link to native code at compilation and call the appropriate built-in routines to execute the sequence flow required to process eligibility checks, offer rendering and offer conversion.

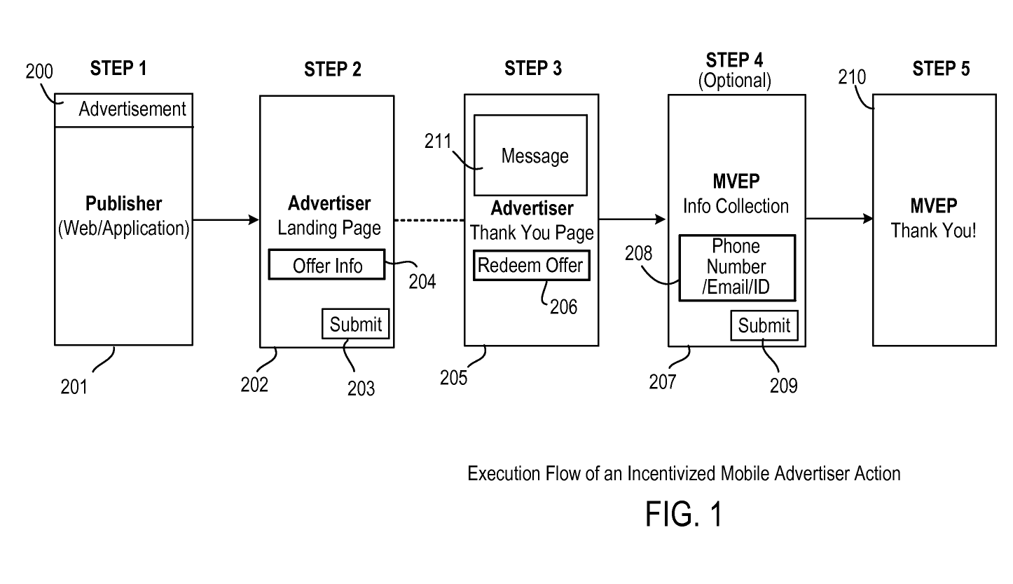

FIG. 1 is an example of a user interface flow. In Step 1, a user of a client device accesses published content 201 (for example, a web site, web portal, mobile website, or mobile application). In conjunction with the published content the user may be presented with an advertisement.

In some implementations, there may be an indicator on the advertisement 200 that informs the user that selecting the advertisement will result in the presentation of an offer. The indicator may be dynamically generated when the advertisement is presented on the client device. In this example, the user selects the advertisement 200, such as by clicking or tapping on the advertisement 200, which causes the user interface of the client device to proceed to step 2. In some implementations, the carriage (bandwidth) related to the user presentation of the advertisement is zero-rated, that is, the user is not being charged for the usage and/or it does not count towards the data allotment associated with their wireless account.

In Step 2, the user of the client device is presented with an advertiser landing page 202. The advertiser landing page 202 includes information about an offer 204. Generally, the offer includes a reward offered in return for the performance, by the user, of an incentivized action. In some implementations, the reward may be predetermined, selected from a predetermined list of potential rewards, determined based on some determined characteristic of the user, or dynamically generated for the user. The reward may be dynamically generated based on the amount spent on the campaign to date (campaign spend), the budget of the campaign, the amount of time left in the campaign, the time and date, and/or the target conversion rate. For example, if the current conversion rate is below the target conversion rate then the size of the reward may be increased, if the current conversion rate is above the target conversion rate then the reward may be decreased, if the rate at which the campaign is spending its budget at a rate that indicates the budget will be spent before the end of the campaign then the offered reward may be smaller. In contrast, if the campaign is spending its budget indicates the budget will not be spent before the end of the campaign then the reward may be larger.

In some implementations, the size of the reward may be limited by a third party associated with the reward. For example, a wireless operator may limit the amount of additional bandwidth that a user may receive. The limits may be applied on a per offer basis or over a period of time. For example, a wireless operator may state that a user may not receive more than 100 MB of additional data at one time or more than 1 gigabyte of additional data during a month. In some implementations, the user may be asked to opt-in for the service and agree to terms and conditions.

Incentivized actions can include downloading a game, downloading an application, unlocking paid features of an application, performing specified action within an application (such as, opening the application, reaching a predetermined level in a game, etc.), providing an e-mail address to an advertiser, providing demographic information, completing a survey, making a purchase, and testing a sponsored service.

An offer may include, for example, an offer to add bandwidth to the user's mobile account or to credit some monetary amount to their wireless bill. The offer may also include others to give credit to an on-line (such as AMAZON.COM) or brick and mortar store (such as ANN TAYLOR), a gift certificate, coupons for a discount on goods and services, early access to content (e.g. access to content before it is available to the general public), unlocking pay-per-view digital content, credits toward specific content on a digital store (such as a particular song, movie, or television episode), etc. The user is presented with a submit button 203 that enables the user to accept the offer.

In some implementations, not all users are presented with offers. The determination to present a particular user with an offer may be determined before the advertisement 200 is presented in Step 1 or when the advertisement 200 is selected.

In some implementations, the carriage (bandwidth) related to performing the incentivized action is zero-rated, that is, the user is not being charged for the usage and/or it does not count towards the data allotment. For example, if a user is made an offer of additional bandwidth for watching a video, the user will not be charged for, or the content provider will pay for, the usage of mobile data necessary to view the video.

Once the user has completed the incentivized action, in Step 3, the user interface displays a thank you page 205. The thank you page 205 includes a message 211 from the advertiser. The page also includes a link 206 or other mechanism that enables the user to redeem the offer and collect the reward.

In Step 4, if the user has not been identified, the user may be presented with an information collection page 207. The information collection page 207 requests identification information 208 about the user. For example, the information collection page may request a phone number, email address, or that the user log into a particular service for the purpose of identification (such as a social networking site like FACEBOOK, or TWITTER). Once the user submits the identification information 208, for example by clicking or tapping the submit link 209 the user receives the reward. In scenarios where the identity of the user is known with sufficient specificity to enable the redemption of the reward without requesting additional information, the information collection page may not been shown, allowing for a frictionless experience.

In step 5, the user is notified that the reward has been redeemed through a confirmation page 210.

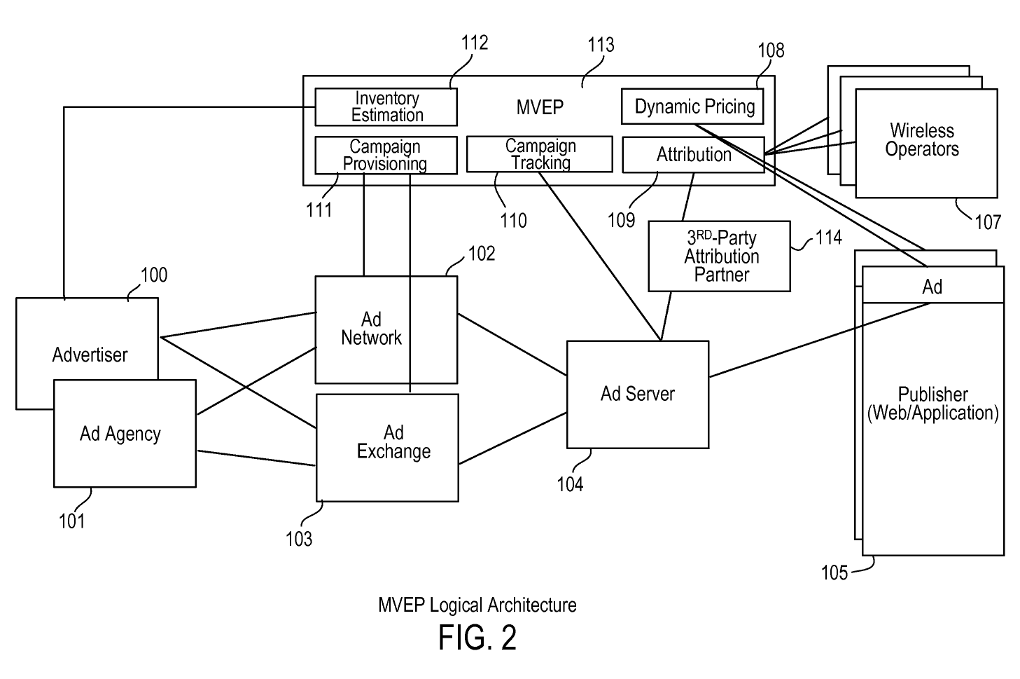

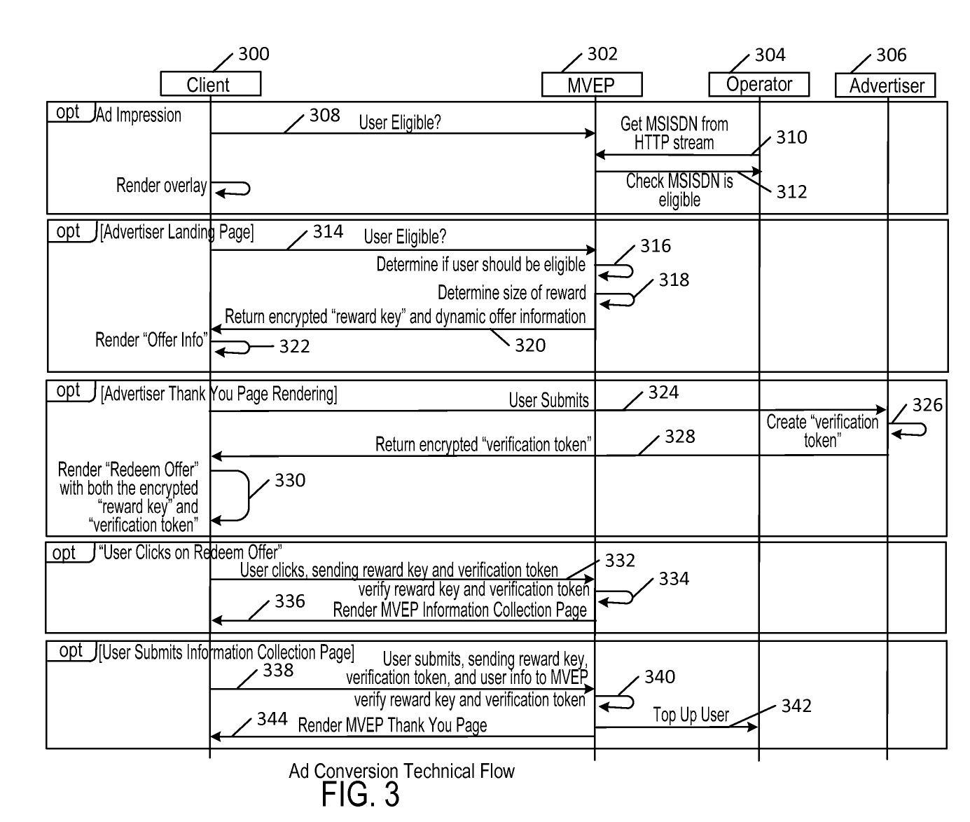

FIG. 2 is a conceptual representation of a logical architecture for a MVEP. The MVEP is a system that enables an advertiser to offer rewards to a user in exchange performing an incentivized action.

An advertiser 100 or advertisement agency 101 organizes an advertisement campaign to promote a good or service. Some advertisers work through an advertisement agency 101, which acts as a surrogate to the advertiser and typically handles technical operations associated with booking and configuring the advertisement campaign. An advertisement campaign can be targeted toward a particular market segment. Markets may be segmented based on demographics, including but not limited to, age, gender, region of the country, income, etc. Markets may also be segmented based on areas of interests of users, for example, baseball enthusiasts, athletes, book readers, movie goers, etc.

An advertisement network 102 connects advertisers to web sites and applications that want to host advertisements. An advertisement exchange 103 facilitates the buying and selling of advertising between one or more advertisement networks. Generally, an advertiser 100 or an advertisement agency 101 supplies ads to an ad network or ad exchange along with a description of the target market segment and a budget that indicates how much the advertiser is willing to spend. The advertisement network or advertisement exchange identifies websites and applications that are compatible with the target market segment and places the ads with those websites and applications.

An advertisement server 104 provides the advertisements to the identified websites or applications for presentation to a user. Generally, the advertisement server can be updated to include new advertisements by the advertisement network or the advertisement exchange. The advertisement server may also track the number of impressions and the number of clicks a particular advertisement receives.

A publisher delivers a website or application 105 to the user's client device. The publisher may be, for example, the owner of the website or the developer or distributor of the application. A MVEP manages and organizes the delivery of rewards-based advertisements to users. When the advertiser 100 or ad agency 101 creates a new campaign, the advertiser defines a target market segment and a budget. An inventory estimation component 112 of the MVEP provides input to an advertiser about the potential size of an audience.

A campaign provisioning component 111 enables the advertiser to configure the parameters under which the advertiser wishes to the reward-based advertisement to run. The parameters can include targeting information such as demographics, network type, device operating system, country, languages, etc. The parameters can also include a start and end date for the advertisement campaign and budget information, such as daily spend, total spend, max spend per conversion, etc. The parameters can also include a definition of the action to incentivize (e.g. watching a video to completion, collecting an email address, using a custom widget such as a store locator, etc. . . . ).

In some implementations, the campaign provisioning component 111 generates a computer program (or piece of software code) for the advertiser to include in the advertisement. The generated program is used to determine reward eligibility and to present the offer.

A campaign tracking component 110 can track the performance of the advertisement. The performance metrics that can be tracked include the number of times an offer is made, the number of times the offer is accepted and redeemed, the click through rate, the conversation rate, the conversion cost, and the budget spend.

For example, an advertiser running an e-mail capture campaign decides to incentivize the campaign. The advertiser offers 100 MB of additional bandwidth for each e-mail collected. In this example, a conversion occurs when a user submits the user's e-mail address.

An attribution component 109 can attribute a conversion to a particular user. The correct attribution can be determined through a uniform resource locator (URL) that is presented when the incentivized action is performed. In some implementations, the URL enables the user to directly communicate with the attribution component. For example, the URL may link to a webserver that is part of the attribution component. In other implementations, the URL links to the ad network 104 running the campaign, which in turn notifies the attribution module 109. In other implementations, the URL links to a 3rd Party Attribution Partner 114, which in turn notifies the attribution module 109.

A dynamic pricing module 108 can compute the value of an offer. The computation can occur as the advertisement is being presented to a user. The value of the offer can be based on eligibility, the status of the user's wireless account, wireless operator restrictions on earning thresholds, and various campaign performance goals. For example, determining the eligibility of the user can include determining whether the user is within the target market segment. The status of the user's wireless account can be used to determine whether the user would be receptive to an offer of increased bandwidth. For example, if the user has an unlimited data plan, the user is unlikely to be receptive to an increase in their available data bandwidth, alternatively the Wireless operator 107 may have imposed restrictions that make the use ineligible for further data bandwidth rewards.

In some implementations, the MVEP 113 can communicate directly with wireless operators 107 to determining information about the user's account. For example, the wireless operator may indicate whether or not a particular user has a limited data plan. A subscriber lookup can be invoked by the MVEP platform to retrieve subscriber information. Given a MSISDN (e.g. the phone number associated with a device) or a unique IP address, the MVEP can obtain information about the account attached to this MSISDN or that IP address. The information can include account number, billing information, usage information, wireless plan definition, billing cycles, device information, etc. Account attributes can be used to determine user eligibility as well, negating the need to expose a separate eligibility interface.

FIG. 3 is a sequence diagram illustrating an example of an advertisement conversion. A client 300, for example, a user of a web browser on a mobile client device requests a display of an incentivized ad. Code in the ad causes the client device to send a message to the MVEP 302 requesting whether the user of the client device is eligible to receive an offer 308. Not all users are necessarily eligible for a reward. Eligibility may be dependent on different factors depending on the reward. For example, in order for a user to receive a mobile data reward the user may have to have an account with a wireless operator that is integrated with the MVEP.

In order to determine eligibility, the MVEP can identify the user. The user may be identified based on IP address identification, HTTP header enrichment, or cookie-matching techniques as discussed below. In some implementations, the MVEP can store information about a user once the user is identified. The information can be used to identify the user for subsequent offers.

In the example, the operator 304 inserts the MSISDN of the user into the HTTP header 310. The MSISDN can be extracted by the MVEP.

To determine eligibility, the MVEP can contact the wireless operator 312 to determine if the user is eligible. For example, before offering a reward of additional mobile data, the MVEP may contact the wireless operator to determine if the client device is eligible to receive the reward.

Eligibility for the reward may also be determined based on the campaign parameters supplied by the advertiser. For example, the advertiser may wish to limit e-mail collection to adults over the age of 18, or to users who have expressed an interest in “Sports”, or any other criteria. The MVEP may attempt to ascertain whether the user is known to fit into the category that is eligible for a reward.

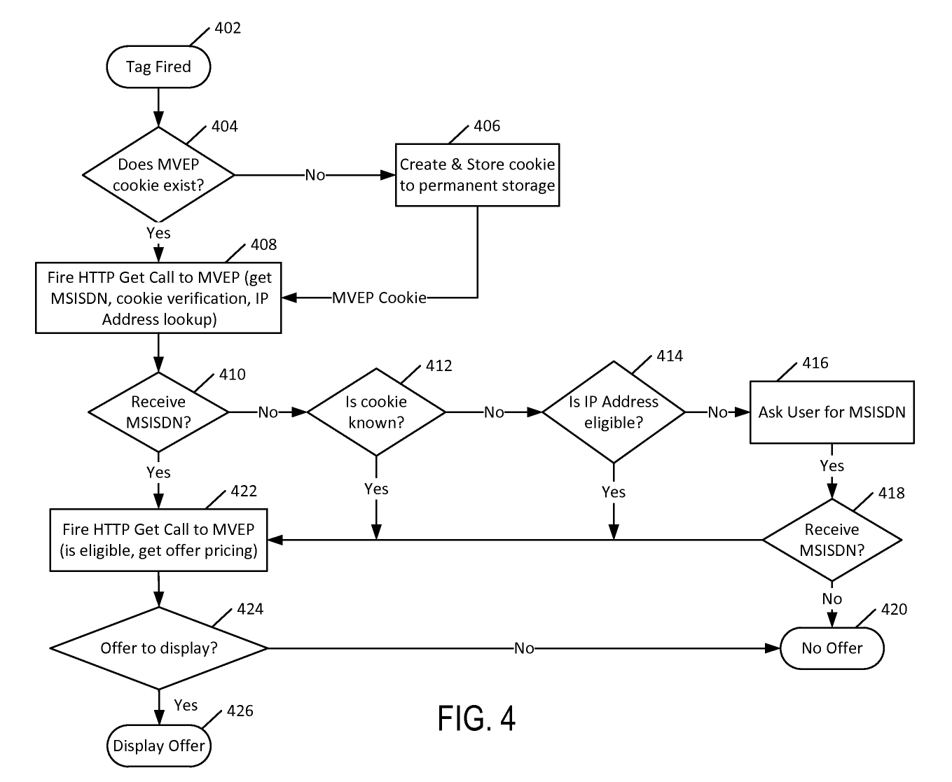

FIG. 4 is a flowchart of an example of a process for determining if a user is eligible for a reward of mobile data. The process begins when the advertisement is presented 402. A scripting tag embedded with the advertisement may cause the client device to initiate the process.

The script determines if a cookie or other identifying data exists 404. If a cookie does not exist the MVEP creates a permanent cookie for the device 406.

The script causes the client device to submit a request to the MVEP 408. The request may be, for example, an HTTP GET request. The HTTP request may include additional information. For example, a wireless operator may embed the MSISDN of the client device into the HTTP header. The HTTP request may also include the cookie.

The MVEP attempts to retrieve the MSISDN from the HTTP header 410. If the MSISDN is not available, the MVEP determines if the cookie is recognized by the system 412. If the cookie is not identified then the MVEP determines whether the IP address of the client device falls within a range of IP addresses that are eligible to receive a reward 414. If after these steps the MVEP cannot identify the device, the MVEP can request that the user provide the MSISDN 416. If the user does not supply the MSISDN then no offer is made 418 and the process terminates 420.

The MVEP can determine from the MSISDN whether the user is eligible, as described above 422. If the user is eligible, an HTTP Response can be used to communicate the offer to the client device.

If there is an offer to display 424 then the client device can display the offer 426.

Referring back to FIG. 3, upon determining that the user is eligible, the MVEP informs the client device. In response the client device renders an overlay over the ad 314.

Once the user selects the advertisement, the user navigates to the Advertisers landing page.

The client device sends a request to the MVEP which may again determine whether the user is eligible for a reward 316, 316. In addition to determining whether or not the user is eligible the MVEP also determines the size of the reward should be offered 318.

The size of the reward can be based on, for example, known information about the user. The known information can include demographic information such as age, gender, location, salary. The known information can include account information such as the user's current data plan, the amount of data the user uses, the amount of data the user has available, the type of device, the type of connectivity (Wi-Fi vs. cellular, and the type of cellular network), how much time remains in the current billing cycle. The known information can also include information about the user's receptiveness to previous offers. For example, if a user has already seen a particular offer the system may determine to increase or decrease the offer based on the user's previous response.

Information about the user may be obtained from various sources including first-party data that the customer provides directly, for example, by creating a user profile or responding to surveys. Information about the user may also be obtained from third party data, the third party data may be provided by, for example, mobile operators, internet service providers, and other data providers.

The size of the reward can also be based on the campaign parameters. For example, the size of the reward may be based on the time and day, the number of days into the campaign, the total available budget, the publishers, the type of publisher, the location of the advertisement, the type of the advertisement, etc.

The size of the reward can also be based on the conversion performance. For example, the size of the reward may be based on the conversion rate targets, the total available budget, the number of days left in the campaign.

Once the size of the reward is determined, the MVEP returns a reward key to the client device, the reward key, which uniquely identifies the reward being offered to the client, and dynamic offer information, which can include for example the size of the reward being offered 320. The reward key may be encrypted.

The client device renders the offer information on the user interface. 322

Once the user completed the incentivized action 324, the advertiser creates a verification token 326. The advertiser can encrypt the verification token and return the encrypted token to the user 328. In some implementations, the token may be encrypted using standard communication protocols, such as the secure sockets layer.

Upon receiving the verification token the system renders the redeem offer link on the client device 330.

Once the user clicks the redeem offer link, the client device sends the verification token and the reward key to the MVEP 332. The MVEP verifies the reward key and the verification token 334.

In some implementations, the MVEP can verify the verification token algorithmically. For example, the advertiser may sign the verification token using a private key or encrypt the token using a public key associated with the MVEP. Other verification systems may also be used, for example, the advertiser may generate the verification token using a key generation algorithm that generates a unique code for a particular reward.

The MVEP can attempt to identify the user. For example, a mobile operator may insert the MSISDN of the client device into an HTTP Header. The amount of information required to identify the user may vary depending on the reward being offered. For example, the MSISDN of the user device may be sufficient to grant a mobile data reward. However, other rewards may require additional data such as name, address, e-mail address, etc. For some rewards, such as an electronic gift card, an e-mail address might be sufficient and does not require additional data that needs to be passed to the MVEP.

If the MVEP is unable to sufficiently identify the user, the MVEP sends an information collection page to the client device 336. The client device renders the information collection page to the user. The information collection page requests the information sufficient to reward the user. The user provides the necessary information into the inventory collection page and submits the inventory collection page to the MVEP 338.

The MVEP verifies the reward key and verification token 340. In some implementations, the MVEP can verify the identifying information of the user. The MVEP then contacts the wireless operator to credit the user with their reward 342. The reward can be, for example, a credit for additional wireless data on the user's wireless account. In some implementations, the reward can be a credit payment for the cost of the additional data. Once the reward is properly credited, the MVEP sends a confirmation Thank You page to the client 344.

In some implementations, rewards may be stored and accumulated during a period of time and applied to the user's account all at once. For example, the MVEP may track the rewards earned by a user per hour, day, week, or month. At the end of the period the MVEP can contact the wireless operator to credit the user. In some implementations, the MVEP contacts the user once the reward is credited. For example, the MVEP may send an automated e-mail or text message to the user.

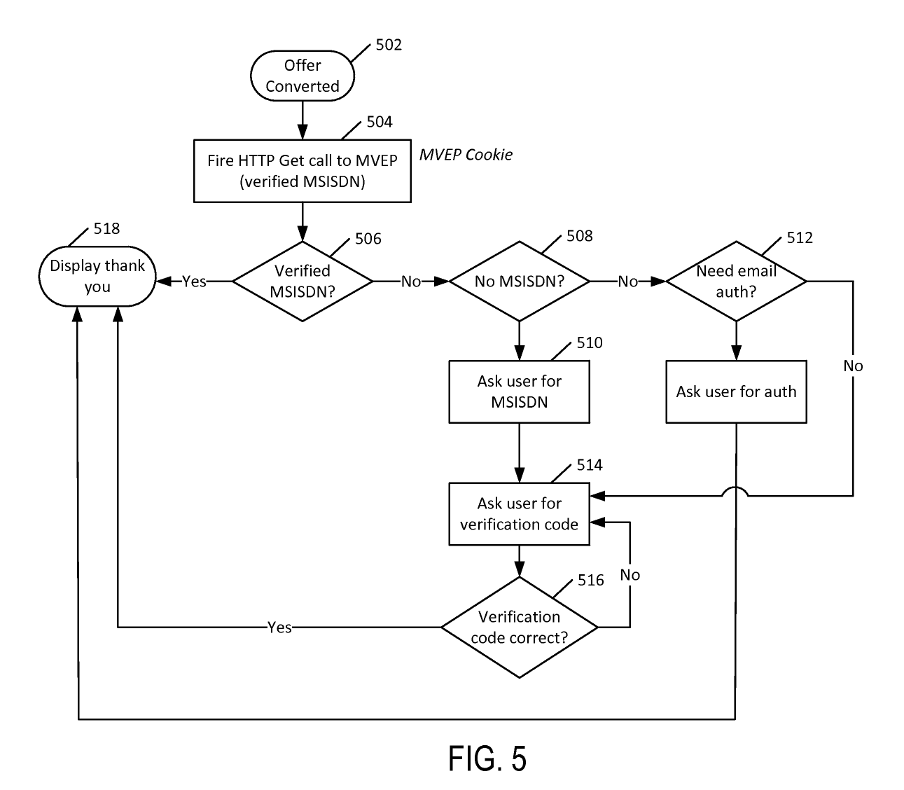

FIG. 5 is a flow chart of an example of a process for offer redemption. The process begins when the offer is converted 502. The client device sends an HTTP Get request to the MVEP 504. The GET request may include the MSISDN of the device.

The MVEP determines whether a verified MSISDN has been provided 506. A verified phone number can be provided by, for example, by sending a text message including a verification code to the user's client device. Because only the user has access to the device, the user is the only one capable of providing the verification code.

If there is no MSISDN 508 then the MVEP sends a message to the client device requesting the user provide the MSISDN of the device 510. The MVEP determines if it needs e-mail authorization 512. For example, to redeem some offers, such as an electronic coupon or gift card, an email address needs to be provided and verified. If an e-mail authorization is required the MVEP sends a message to the client device requesting that the user provide the authorization 514. Alternative, if the user has signed on using a single sign on system, then the e-mail address may be obtained without sending the request to the user.

In either case, the process requests the verification code 514. The process verifies the code. If the code is incorrect or invalid, the process requests the code again.

At the completion of the process, the process sends a thank you page to the client device for presentation to the user 518.

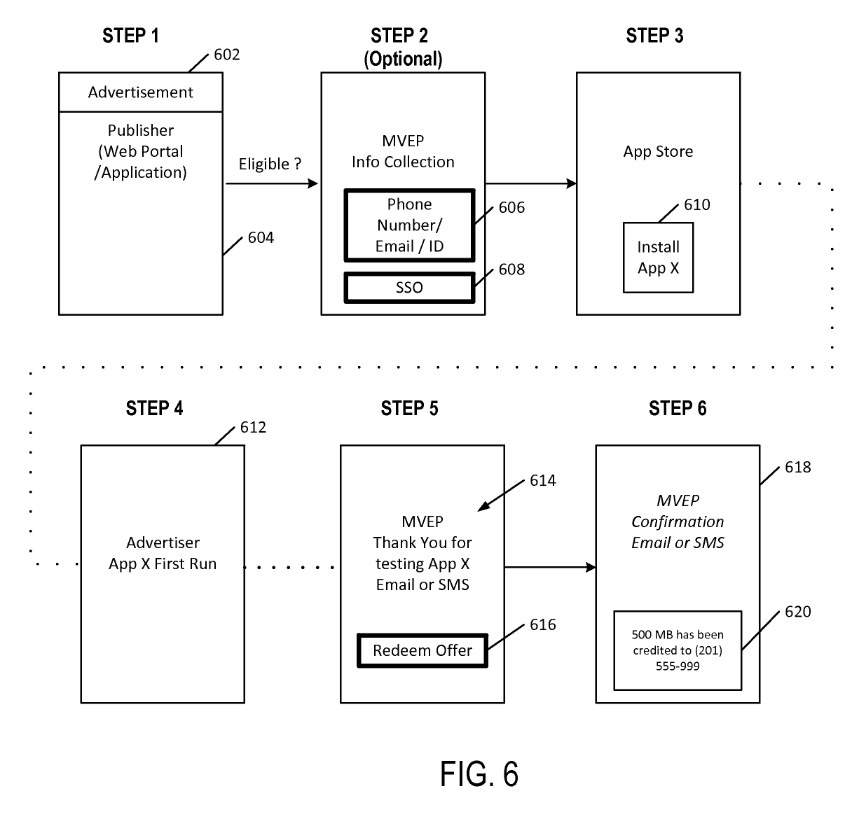

In addition to incentivizing advertisements placed on a web page, the system can also incentivize advertisements to install and use an application on a client device. FIG. 6 illustrates a user interface flow of incentivizing the installation and execution of a mobile application.

In Step 1, a user of a client device accesses published content 604 (for example, a web site, web portal, mobile website, or mobile application). In conjunction with the published content the user may be presented with an advertisement for a mobile application 602.

As described above, in some implementations, there may be an indicator on the advertisement 602 that informs the user that selecting the advertisement will result in the presentation of an offer. The indicator may be dynamically generated when the advertisement is presented on the client device. In this example, the user selects the advertisement 602, such as by clicking or tapping on the advertisement 602, which causes the user interface of the client device to proceed to step 2 or step 3.

In step 2, the user of the client device is optionally presented with an information collection screen. The information collection screen includes an area for providing requested information such as the user's phone number, e-mail address, or other type of identifying information 606. The information collection screen can also include a place to log into a single sign on service, such as a service provided by a social networking site. In scenarios where the MVEP has sufficient information about the user to identify the user and provide the reward, step 2 may be skipped and the client device may proceed directly to step 3.

In step 3, the client device is directed to the app store, where the user can install the advertised application 610. Step 4 occurs when the user executes the application for the first time 612. When the application is executed, the MVEP can be notified that the user has earned the reward. The MVEP can send an e-mail or other message (such as a SMS text message) to the client device.

In step 5, the client device displays the message 614 from the MVEP. The message includes instructions or a link whereby the user can redeem the offer 616. For example, the message a link that sends an HTTP Request to the MVEP. In other examples, the message may include instructions for the client device to send a text message containing a code to a particular telephone number.

Once the MVEP has provided the reward to the user, the MVEP can send a confirmation email or other message to the client device. In step 6, the client device displays the confirmation message 618 with the details of the reward 620.

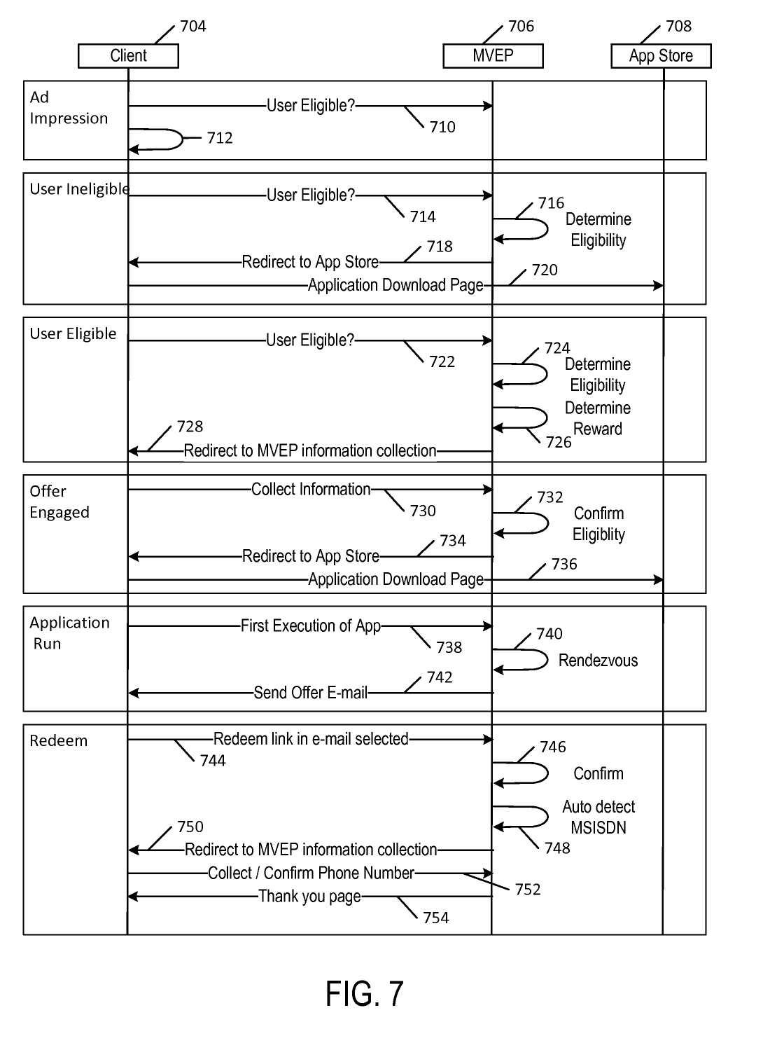

FIG. 7 is a sequence diagram illustrating further detail of an example of a process of presenting an offer for a reward for downloading a mobile app. As discussed above with respect to FIG. 3, a user is presented with an advertisement. As described above, the advertisement can cause the client device 702 of the user to send a message to the MVEP 706 to determine if the user is eligible to receive an offer 710. If the user is eligible for an offer, the client device renders an overlay over the advertisement 712.

Once the user clicks on the advertisement, there are two scenarios shown. In the first scenario the user is ineligible for an award, in the second scenario the user is eligible. Both scenarios begin similarly. The client device sends a message to the MVEP to determine if the user is eligible for an offer 714, 722. The MVEP determines eligibility as described above with respect to FIG. 3 716, 724.

In scenarios where the user is not eligible for an offer, the client device is redirected to the App store 718. The redirected client device navigates to the application download page of the App Store 720.

If the user is eligible for the award the size of the award is determined 726 and the user is presented to an information collection page 728. The information collection page may request information such as the e-mail address of the user. In some implementations, the information collected is used to determine eligibility. For example, the information may include a survey of demographic information about the user. The user provides the requested information 730.

The MVEP can confirm that the user is eligible to receive the reward 732. In some implementations, the MVEP uses the provided information to confirm eligibility. Once eligibility is confirmed, the client device is redirected to the App store 734. The redirected client device navigates to the application download page of the App Store 736.

At some later time, when the user executes the mobile app, the client device sends a message to the MVEP 738. In some implementations, the mobile app may be programed to communicate with the MVEP or with a third party attribution service 740. The third party attribution service may notify the MVEP on the client's behalf. The message informs the MVEP that the mobile app has been run.

The MVEP sends the offer e-mail to the client device 742. The e-mail includes a link that enables the user to redeem the reward. In some implementations, the e-mail may include a subsequent offer, for example, additional data for performing some subsequent action. The link may include, among other information, an encrypted validation code.

The user selects a link in the e-mail. For example, the user may click or tap a link in the e-mail message. Selecting the link causes the client device to send a message to the MVEP 744. The MVEP confirms that the message is valid 746. For example, the MVEP may confirm that the validation code send with the link is a valid validation code. The MVEP attempts to automatically detect the MSISDN of the client device 748, as discussed above.

If the MVEP is unable to detect the MSISDN of the client device, the MVEP sends a HTML page to the client device 750 requesting that the user provides the phone number of the client device. In some implementations, if the MSISDN of the client device is determined, the MVEP sends a HTML page asking the user to confirm the phone number of the client device.

The user provides or confirms the telephone number of the client device 752. The MVEP credits the user's account, as described above, and sends a Thank you message to the client device 754.

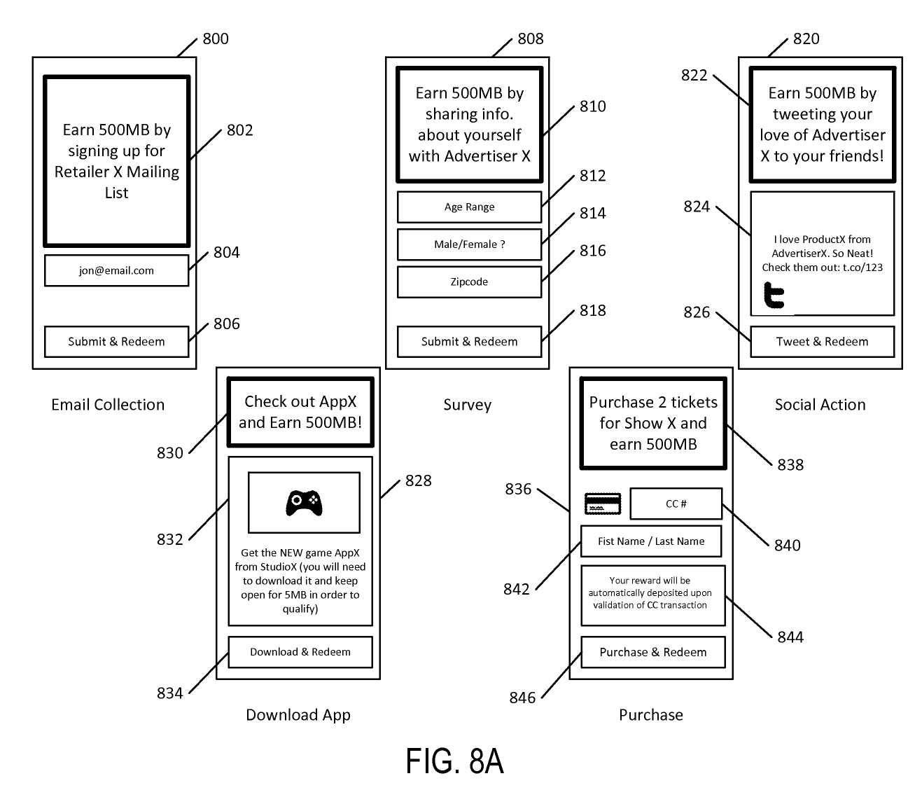

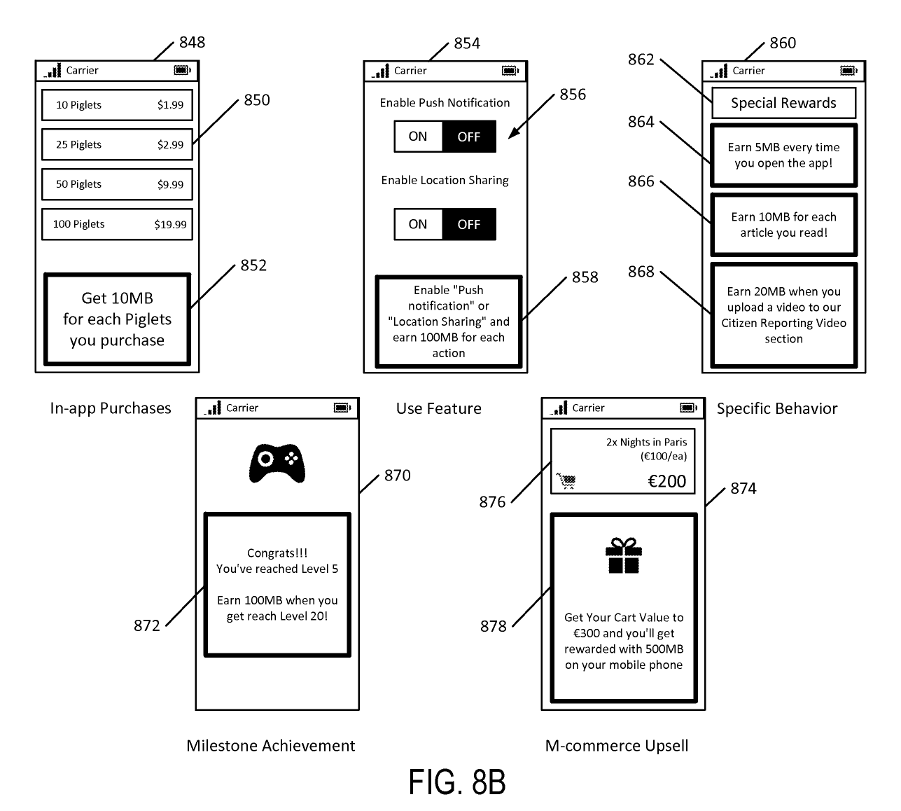

FIG. 8A-B illustrates some examples of the presentation of different offers. The MVEP can manage offers related to different incentivized actions. Among the types of incentivized actions the MVEP can support are the collection of e-mail addresses, surveys, interactions with a social networking site, mobile app downloads, purchases, in-app purchases, feature enablement, specific user behaviors, milestones achievement, and upselling in commerce.

Referring to FIG. 8A, in some implementations, the offer and the incentivized action can be combined into a single webpage. For example, the user interface 800 presents the offer 802 for 500 MB of mobile data for signing up to a mailing list. In this example, the offer 802 is presented along with an input field 804 where the user can supply their e-mail address and subscribe to the mailing list by selecting the select and redeem link 806.

In another example, the user interface 808 presents an offer 810 for 500 MB of mobile data for providing demographic information to the advertiser. In this example, the offer 810 is presented along with input fields 812 814 815 where the user can identify an age range, gender, and zip code. The information can be submitted and the offer redeemed by selecting the select and redeem link 818.

In another example, the user interface 820 presents an offer 822 for 500 MB of mobile data for endorsing the advertiser through a social networking application. In this example, the offer 822 is presented along with an input field 824 where the user can provide the customized the endorsement message. The endorsement can be submitted to the social networking site and the offer redeemed by selecting the select and redeem link 818.

In another example, the user interface 828 presents an offer 830 for 500 MB of mobile data for downloading and accessing a mobile app. In this example, the offer 830 is presented along with a link 830 where the user can download the mobile app. The user interface includes further details about the offer 832. The details can define the conditions under which the user will receive the reward. The mobile app can be downloaded and the offer redeemed by selecting the select and redeem link 834.

In another example, the user interface 836 presents an offer 838 for 500 MB of mobile data for purchasing tickets to an event. In this example, the offer 838 is presented along with input fields 840 842 844 where the user purchase the tickets. The tickets can be purchased and the offer redeemed by selecting the select and redeem link 846.

Referring to FIG. 8B, in another example, the user interface 848 presents an offer 852 for 10 MB of mobile data for each purchasing virtual items in a game, in this example a “piglet”. In this example, the offer 852 is presented along with selection fields 850 enable the user to easily purchase the virtual “piglets” and redeem the offer.

In another example, the user interface 854 presents an offer 858 for 100 MB of mobile data for enabling push notifications and location sharing. In this example, the offer 858 is presented along with an input field 856 where the user can provide enable push notifications and location sharing. Turning on either of these features will result in redeeming the corresponding offer.

In another example, the user interface 860 presents offers to earn 5 MB for opening an app 864, earn 10 MB for reading an article 866, and earn 20 MB for uploading a video 868 to incentivize using a mobile app and participating in an online community. In this example, the user interface does not include specific mechanisms to redeem the offer. Instead the offer is redeemed when the user performs of the incentivized actions.

In another example, the user interface 870 presents an offer 872 for 100 MB of mobile data for reaching a milestone in a mobile application, in this example, reaching level 20. In this example, the offer 872 is presented once the user reaches level 5 in the mobile app.

In another example, the user interface 874 presents an offer 876 for 500 MB of mobile data for increasing the amount of items purchased. In this example, the offer 876 is presented along with a visual representation of the value of items that the user has already selected for purchase 878 along with a value.

The MVEP attempts to make the presentation and acceptance of an offer to be “frictionless”. By frictionless we mean that it is easy and unobtrusive for a user to agree to an offer and perform the incentivized action. Because typing on a small keyboard is cumbersome, one of the ways that the MVEP can make it easier for the user to earn rewards is by reducing the amount of information required to redeem the reward. When practicable the MVEP can determine the identity of the user or the user's client device without asking intrusive questions.

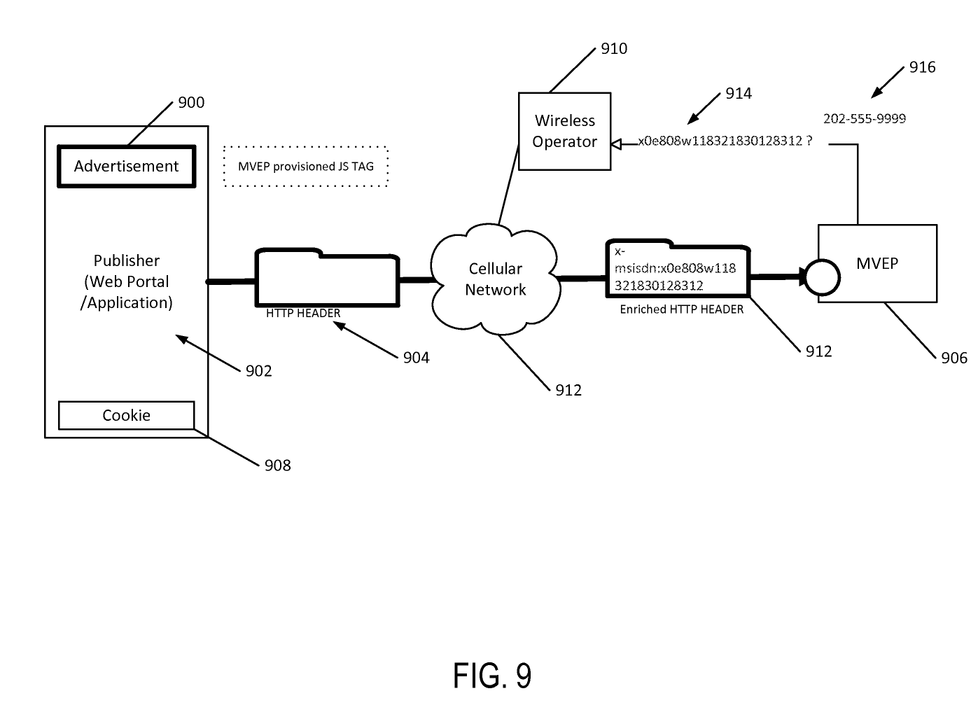

Referring to FIG. 9, one mechanism for identifying a client device is HTTP enrichment. HTTP header enrichment is a technique used to pass additional information about a client party to a destination while traversing network gateways and routers possessing the ability inject information into HTTP headers. For instance, an advertisement 900 being displayed on a publisher property 902 could fire a HTTP call to a specific web endpoint (e.g. domain name) operated by the MVEP platform 906. That HTTP call, fired when the MVEP provisioned scripting tag is executed when the ad 900 is rendered contains a cookie 908, generated by the scripting tag and stored locally on the device. A wireless operator 910 provisioned a rule on their network so that for every HTTP stream going thru their cellular network 912, an additional field is added to the HTTP header 904 of that stream, containing an encrypted version of the MSISDN of the user device. Upon processing the HTTP stream, the MVEP platform 906 reads the additional field and makes a request into the wireless operator's network 910 passing the encrypted MSISDN 914. In return the wireless operator 910 replies with the decrypted MSISDN 916 and associates that MSISDN 916 to the device cookie 908 in its database on the MVEP 906.

When a later HTTP request is received with the cookie 908, the MVEP 906 can identify the client device without subsequent requests being made to the wireless operator even if the client device is not connecting through the cellular network 912, for example, if the client device is connected to a Wi-Fi network.

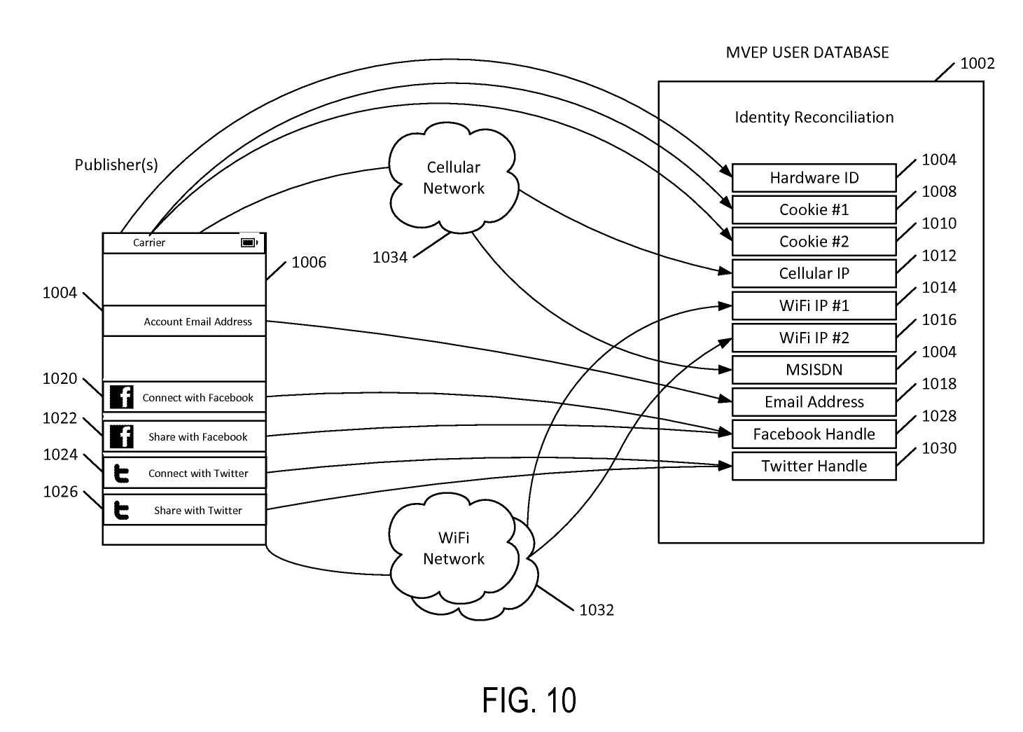

Information identifying the user and client device can be stored in a database. Referring to FIG. 10, in order to further make the reward redemption as frictionless as possible, e.g. reducing the number of steps a user has to complete and the amount of information the user has to provide, the MVEP platform consolidates unique information and attributes collected for a specific user across multiple sessions and interactions with offers into an Identity Reconciliation database 1002. For instance the hardware ID 1004 of a device 1006 running an MVEP augmented offer could be collected. Various cookies 1008, 1010, stored locally on the device that was used when presented past offers can be stored in the database. The cellular IP 1012 corresponding to the IP session can be collected during an eligibility requests if the device is connected over a cellular connection 1034 or various Wi-Fi IPs 1014, 1016 can be collected if the device is connected to Wi-Fi access points 1032. When offers involve user to input their email address 1018, connect 1020 or share 1022 on FACEBOOK or connect 1024 or share 1026 on TWITTER, the email address 1018, Facebook handle 1028 or Twitter handle 1030 can be collected and stored in the database. Unique information is used to key off further additions to the records of a specific user. For instance, a hardware ID passed during an IP session could be used as key to store the IP address of that session. When processing a user redemption request, the MVEP first determines if it has collected enough information from the user by looking it up in the database. For instance, it could determine based on cookie matching or hardware ID matching that the MSISDN for that user is already known or that the email address required to process the reward is already available. If additional information is required, the MVEP will present the user with an offer collection page.

As discussed above, not all users receiving the advertisement will be eligible for a reward. If the use is eligible, the amount the user is eligible for needs to be computed. In addition, for publishers that do have measurable cost for incentives, the pricing for those incentives is fixed and directly tied to the price the advertiser is willing to pay. Generally, the advertiser desires to have the possible offer that will lead the maximum number eligible users to convert on the incentivized action the advertiser, across the entire flight time of the campaign.

The MVEP platform can calculate dynamic incentivized pricing as a mechanism to change the incentive to the customer dynamically during a campaign, based on a number of factors in a real-time, or near real-time, bidding auction. The MVEP can create a control group, allowing the effect of changes in the offered rewards to the conversion rate to be measured. Based on the control group, the MVEP can create an offered incentive vs. conversation rate curve that allows the system to determine how differing incentive values impacts conversion rate. The MVEP can also enable the party paying for the incentive to control their exposure.

The MVEP can also adjust the size of the offer to control the rate at which the budget is spent. For example, the amount spend on rewards can be distributed evenly throughout the day (or any unit of time, such as spend during lunch hours, 11 am through 2 pm), or can be unpaced (spend as fast as possible).

Pacing of the dynamic incentivized pricing is important in order to prevent over running the budget of the incentives. As the budget of the campaigns draws down, the MVEP can dynamically change the offers presented to users and control how many offers are available for the users to accept. For example, if the number of eligible offer requests is 20,000 every 10 minutes, the system can dynamically change the number of eligible offer responses based on where the campaign according to its planned budget and therefore only make a percentage of the potential offer requests. For example, the MVEP may determine that based on the current rate of expenditure, only 10% of the users who otherwise qualify to receive an offer of a reward will be delivered the offer. In addition, the size of the average offered reward (per unit of time) can be reduced to control spending as well. The MVEP may balance the rate at which the budget is spent with the desired conversion rate, as a decrease in spending may negatively impact conversion rate. For example, if the average offer size for 20,000 eligible offers over a 10 minute period is 100 Mb (which would result in 2,000,000 Mb of offers ‘in-flight’) and the MVEP determines that that rate is too high, the MVEP may either reduce the number of offers made or dynamically shift the average offer size down to 50 Mb, which would result in 1,000,000 Mb of offers ‘in-flight’).

In some implementations, the MVEP can estimate and target a quantified amount of ads inventory that are eligible to be augmented by the MVEP platform to incentivize the call to action with a reward. Estimating and targeting inventory can be used in pre-sales and pre-launch campaign planning. The MVEP service, through the proper operator integration can determine if an ad request is eligible based on some attribute injected into the HTTP header.

However, relying on the operator to identify users who are eligible to receive an offer for a reward (for example, by relying on an attribute inserted into an enriched HTTP header by the operator as described above) can present complications when the user is not operating on the operator's network, for example, when the user is connected to a WI-FI network. Therefore, a user who is otherwise eligible to receive a reward may not be identified.

The MVEP can leverage retargeting in order to more accurately estimate the eligible ad inventory. In general, retargeting is a mechanism for an advertiser to target a user that has taken a specific action on a property (such as a website) owned by that advertiser when that user is presented with an advertisement by a publisher or advertisement network. A content provider can purchase a can establish a retargeting campaign from a publisher or ad network. Retargeting can be accomplished by cookie (or user ID) swapping (also known as tagging).

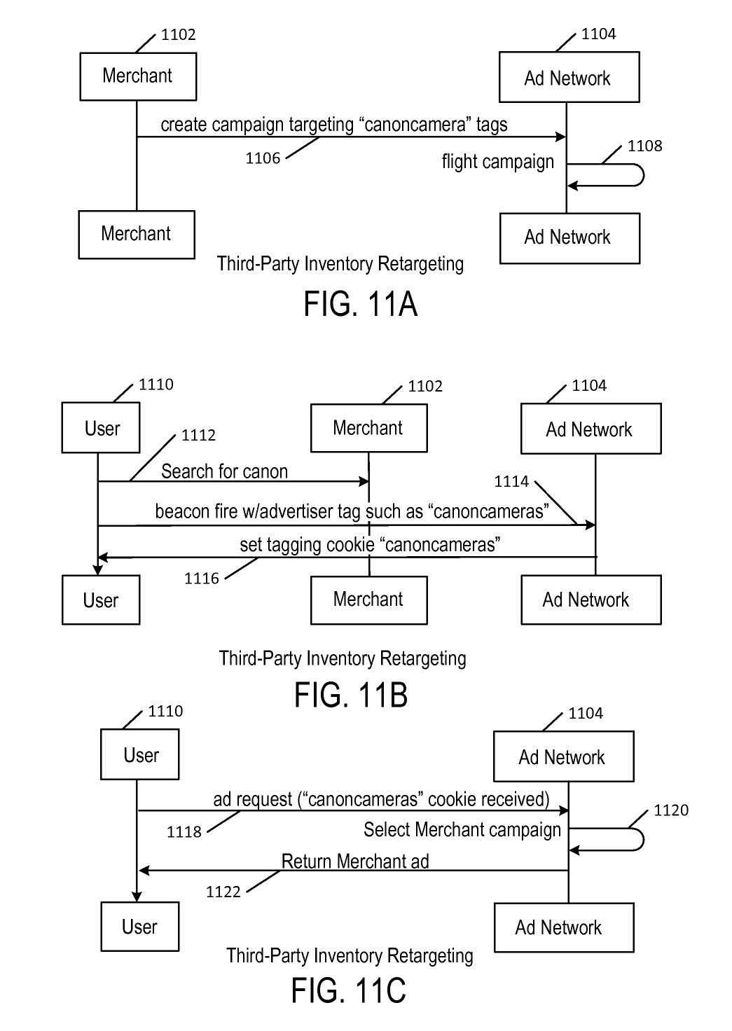

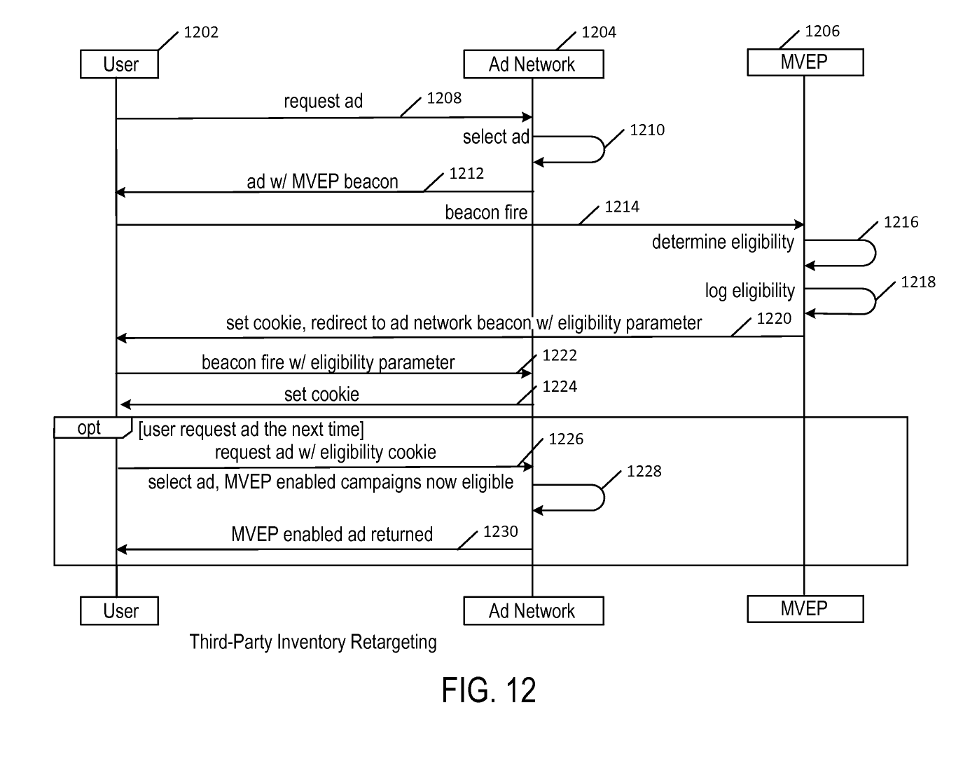

For example, referring to FIG. 11A, a merchant 1102 establishes 1106 a campaign targeting a “canoncamera” tag with an Ad Network 1104. In this example, the campaign can include delivering a merchant ad for 20% off on all Canon cameras. The Ad Network begins (flights) 1108 the campaign.

Referring to FIG. 11B, a user 1110 visits the merchant's 1102 website and search 1112 for “Canon”. The merchant's Canon camera page includes a beacon that informs 1110 the ad network to associate the user with a “cannoncameras” tag. In response, the ad network sends 1116 a tagging cookie for Canon camera to the user. to the user 1102.

Referring to FIG. 11C, later, when the user 1110 requests 1118 an ad from the ad network 1104 the tagging cookie is sent along with the request. The Ad Network 1104 selects 1120 the merchant's campaign from among one or more potential advertisement campaigns. The Ad network 1104 returns 1122 the merchant's ad for 20% off on all Canon cameras.

Eligible users can be more reliably identified using retargeting techniques and cookie pool expansion. Cookie pool expansion uses a tracking beacon to track eligible users. Users tracked by the beacon are marked as eligible when the beacon is triggered while using the cellular network. The client device of the user receives data (referred to as a cookie) that is persistently stored on the device. The storage of a persistent cookie varies depending and device operating system and make; however, several techniques, such as storing the cookie into the persistent storage used to store information that is passed between mobile applications (referred to as a pasteboard), are known in the industry.

To broadly estimate eligible traffic, the MVEP platform can provide the publisher or advertising network with a tracking beacon that they can place on all of advertisements (or optionally a sample of their advertisements). As an example, the tracking pixel could include the following HTML code:

<img src=″http://spotlight.mvep.platform/spotlight?inventory=
advertiser.com″height=″1″width=″1″>

Instead of the example of the 1×1 image-based beacon, a beacon based on a scripting language, for example JAVASCRIPT, can be used. In some implementations, a broader set of attributes to be detected (such as device screen size and device capabilities). Using a scripting beacon may also enable integration with advertiser networks to be updated without updating the beacon definition and by updating the published script sources instead.

Whenever the publisher renders an advertisement-monetized page or an advertisement network returns an advertisement, the beacon is placed within the page or advertisement (for example, at the top of the page or the bottom of the ad). The beacon will result in the client device contacting the MVEP whenever the pages or advertisements are rendered. When the client device contacts the MVEP the MVEP can

1. Read and write cookies on the client device in the MVEP domain

2. Obtain key information such as IP address and browser user agent directly from the browser/application

3. Create a direct network channel from the client to the MVEP platform, enabling operators to add the MVEP platform link to whitelists, which allow the injection of HTTP headers by the operator to the MVEP platform.

This information can be used to distinguish eligible requests from ineligible requests and ‘discover’ the eligibility distribution of a publisher's traffic. In some implementations, a publisher can provide custom attributes and/or parameters that identify certain aspects of their traffic (such as a page identifier for publishers or a publisher name for an ad network). The MVEP can use information derived from the publisher's traffic and the attributes and/or parameters to provide inventory tools to the operational staff of these organizations allowing them facet across these custom attributes to determine more specific eligibility information (how many eligible requests are on my home page vs. my news page for instance).

The tracking beacon enables the MVEP to communicate to a publisher an estimate of how much of their traffic is eligible to receive rewards. Tools and user interfaces can be built for publishers and ad networks to allow them to peer into their inventory and see how much is eligible. However, as describes above, it does not alone provide a means to target the advertisements when the campaign is begun. Instead, the advertiser may have to target a broad campaign and use the MVEP to detect eligibility and serve offers accordingly. An overly broad campaign can create post-launch issues with reconciliation of eligible impressions purchased and actual eligible impressions delivered. To reduce the effect of these issues the MVEP can allow advertisers to retargeting the campaign.

For example, referring to FIG. 14, a user 1202 requests an ad 1208 from an Ad Network 1204. The Ad Network 1204 selects an ad 1210 that includes an MVEP beacon. The ad is returned 1212 to the user. When the ad is displayed or otherwise accessed by the user's client device, the beacon fires and sends a message 1214 to the MVEP 1206. The MVEP 1206 determines the eligibility of the user 1202, and stores the eligibility 1218 in a data store.

The MVEP 1206 then sets a cookie on the user's client device and redirects the client device to the ad network beacon 1220. A second beacon fires and sends a message 1222 to the ad network 1204. The Ad Network may set its own cookie on the user's client device 1224.

The next time the user requests an ad 1226, the cookie informs the Ad Network that the user 1202 is eligible for MVEP offers. The Ad Network selects the appropriate ad 1228 and returns the MVEP enabled ad to the user 1230.

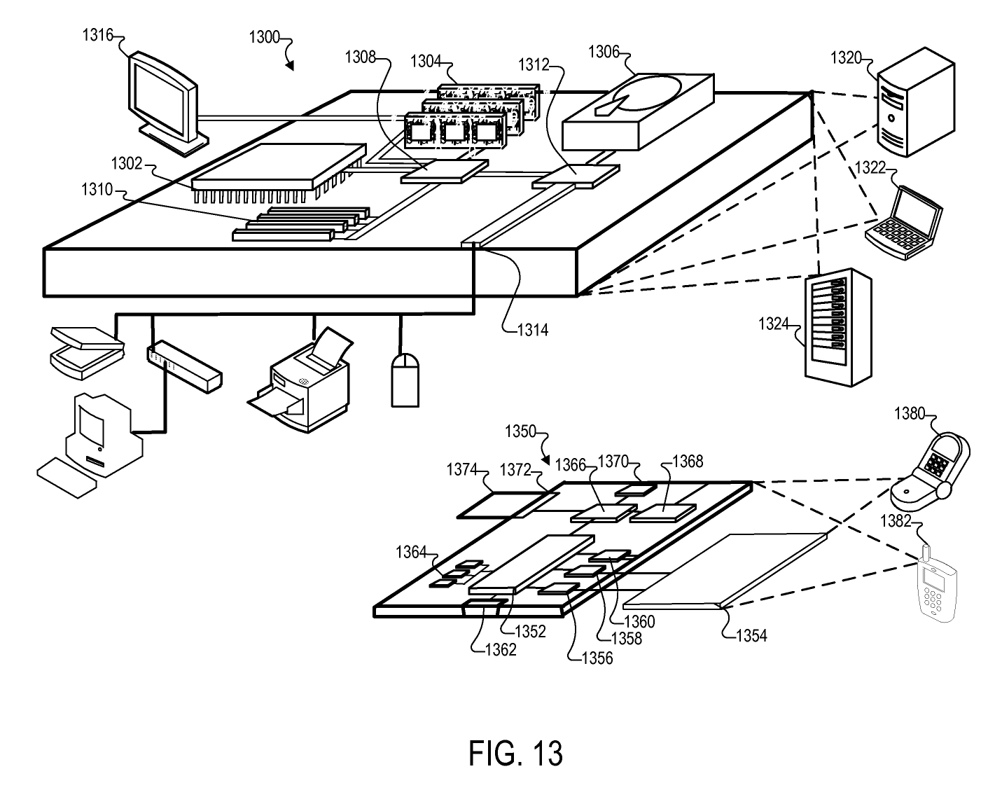

FIG. 13 shows an example of a generic computer device 1300 and a generic mobile computing device 1350, which may be used with the techniques described here. Computing device 1300 is intended to represent various forms of digital computers, such as laptops, desktops, workstations, personal digital assistants, servers, blade servers, mainframes, and other appropriate computers. Computing device 1350 is intended to represent various forms of mobile devices, such as personal digital assistants, cellular telephones, smartphones, and other similar computing devices. The components shown here, their connections and relationships, and their functions, are meant to be exemplary only, and are not meant to limit implementations of the inventions described and/or claimed in this document.

Computing device 1300 includes a processor 1302, memory 1304, a storage device 1306, a high-speed interface 1308 connecting to memory 1304 and high-speed expansion ports 1310, and a low speed interface 1312 connecting to low speed bus 1314 and storage device 1306. Each of the components 1302, 1304, 1306, 1308, 1310, and 1312, are interconnected using various busses, and may be mounted on a common motherboard or in other manners as appropriate. The processor 1302 can process instructions for execution within the computing device 1300, including instructions stored in the memory 1304 or on the storage device 1306 to display graphical information for a GUI on an external input/output device, such as display 1316 coupled to high speed interface 1308. In other implementations, multiple processors and/or multiple buses may be used, as appropriate, along with multiple memories and types of memory. Also, multiple computing devices 1300 may be connected, with each device providing portions of the necessary operations (e.g., as a server bank, a group of blade servers, or a multi-processor system).

The memory 1304 stores information within the computing device 1300. In one implementation, the memory 1304 is a volatile memory unit or units. In another implementation, the memory 1304 is a non-volatile memory unit or units. The memory 1304 may also be another form of computer-readable medium, such as a magnetic or optical disk.

The storage device 1306 is capable of providing mass storage for the computing device 1300. In one implementation, the storage device 1306 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 1304, the storage device 1306, memory on processor 1302, or a propagated signal.

The high speed controller 1308 manages bandwidth-intensive operations for the computing device 1300, while the low speed controller 1312 manages lower bandwidth-intensive operations. Such allocation of functions is exemplary only. In one implementation, the high-speed controller 1308 is coupled to memory 1304, display 1316 (e.g., through a graphics processor or accelerator), and to high-speed expansion ports 1310, which may accept various expansion cards (not shown). In the implementation, low-speed controller 1312 is coupled to storage device 1306 and low-speed expansion port 1314. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 1300 may be implemented in a number of different forms, as shown in the figure. For example, it may be implemented as a standard server 1320, or multiple times in a group of such servers. It may also be implemented as part of a rack server system 1324. In addition, it may be implemented in a personal computer such as a laptop computer 1322. Alternatively, components from computing device 1300 may be combined with other components in a mobile device (not shown), such as device 1350. Each of such devices may contain one or more of computing device 1300, 1350, and an entire system may be made up of multiple computing devices 1300, 1350 communicating with each other.

Computing device 1350 includes a processor 1352, memory 1364, an input/output device such as a display 1354, a communication interface 1366, and a transceiver 1368, among other components. The device 1350 may also be provided with a storage device, such as a microdrive or other device, to provide additional storage. Each of the components 1350, 1352, 1364, 1354, 1366, and 1368, are interconnected using various buses, and several of the components may be mounted on a common motherboard or in other manners as appropriate.

The processor 1352 can execute instructions within the computing device 1350, including instructions stored in the memory 1364. The processor may be implemented as a chipset of chips that include separate and multiple analog and digital processors. The processor may provide, for example, for coordination of the other components of the device 1350, such as control of user interfaces, applications run by device 1350, and wireless communication by device 1350.

Processor 1352 may communicate with a user through control interface 1358 and display interface 1356 coupled to a display 1354. The display 1354 may be, for example, a TFT LCD (Thin-Film-Transistor Liquid Crystal Display) or an OLED (Organic Light Emitting Diode) display, or other appropriate display technology. The display interface 1356 may comprise appropriate circuitry for driving the display 1354 to present graphical and other information to a user. The control interface 1358 may receive commands from a user and convert them for submission to the processor 1352. In addition, an external interface 1362 may be provided in communication with processor 1352, so as to enable near area communication of device 1350 with other devices. External interface 1362 may provide, for example, for wired communication in some implementations, or for wireless communication in other implementations, and multiple interfaces may also be used.

The memory 1364 stores information within the computing device 1350. The memory 1364 can be implemented as one or more of a computer-readable medium or media, a volatile memory unit or units, or a non-volatile memory unit or units. Expansion memory 1374 may also be provided and connected to device 1350 through expansion interface 1372, which may include, for example, a SIMM (Single In Line Memory Module) card interface. Such expansion memory 1374 may provide extra storage space for device 1350, or may also store applications or other information for device 1350. Specifically, expansion memory 1374 may include instructions to carry out or supplement the processes described above, and may include secure information also. Thus, for example, expansion memory 1374 may be provided as a security module for device 1350, and may be programmed with instructions that permit secure use of device 1350. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 1364, expansion memory 1374, memory on processor 1352, or a propagated signal that may be received, for example, over transceiver 1368 or external interface 1362.

Device 1350 may communicate wirelessly through communication interface 1366, which may include digital signal processing circuitry where necessary. Communication interface 1366 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 1368. In addition, short-range communication may occur, such as using a Bluetooth, WiFi, or other such transceiver (not shown). In addition, GPS (Global Positioning System) receiver module 1370 may provide additional navigation- and location-related wireless data to device 1350, which may be used as appropriate by applications running on device 1350.

Device 1350 may also communicate audibly using audio codec 1360, which may receive spoken information from a user and convert it to usable digital information. Audio codec 1360 may likewise generate audible sound for a user, such as through a speaker, e.g., in a handset of device 1350. Such sound may include sound from voice telephone calls, may include recorded sound (e.g., voice messages, music files, etc.) and may also include sound generated by applications operating on device 1350.

The computing device 1350 may be implemented in a number of different forms, as shown in the figure. For example, it may be implemented as a cellular telephone 1380. It may also be implemented as part of a smartphone 1382, personal digital assistant, or other similar mobile device.

In this specification when we have used the following terms, we have used the terms in a broad sense as suggested below.

| We have used | |
|---|---|
| the term below | . . . to include, for example, any of what we refer |
| broadly . . . | to below, among other things. |
| Mobile device or | Any electronic device that can be carried around by |
| wireless device | a user and can communicate wirelessly, for |
| | example, telephones, computers, electronic pads and |
| | tablets, laptops, notebooks, and other devices that |
| | operate on cellular or other wireless telephone |
| | networks or on wireless networks such as Wi-Fi, |
| | Bluetooth, and others. |
| Wireless networks | Any voice or data communication network that |
| | includes a wireless portion through which a user |
| | device communicates, such as a cellular network, |
| | the Internet, LANs, WANs, VPNs, Wi-Fi, and |
| | Bluetooth to name a few. |
| Mobile operators | Any parties that own, control, or operate facilities of |
| | any kind that provide wireless communication |
| | services to customers, such as cellular |
| | communication operators and short-range wireless |
| | network operators. |
| Wireless | Any kind of facility, service, equipment, or |
| communication | capability that enables or delivers or provides |
| services or mobile | wireless communication by a mobile device, such as |
| communication | communication of voice or data or content, |
| services | including mobile and other broadband services. |
| Broadband services | Wireless or mobile or other communication services |
| | that provide a large enough throughput or bandwidth |
| | to permit images, videos, and audio to be presented, |
| | for example, in real-time. |
| Credits | Any sort of representation of value between a party |
| | who owns the credit and a party for whom it |
| | represents a liability, such as, for example, a |
| | voucher, a chit, an entry on an account, an IOU, a |
| | reward, points in a loyalty program, can be used to, |
| Advertising | Any kind of presentation intended, for example, to |
| | inform or influence then thinking or behavior of |
| | others with respect to a product, a service, or an |
| | entity, including, communications, notices, postings, |
| | banners, content, and any other kinds of material or |
| | indicia or packaging or display. |
| Data plan | Any kind of program that defines an ongoing |
| | arrangement for supplying data communication |
| | services such as wireless or mobile communication |
| | services, or broadband services to devices such as |
| | mobile devices. |
| Loyalty program | A program designed to encourage customers of a |
| | product or service to continue or enhance their |
| | relationship to the product or service or to the entity |
| | that supplies it or to promote the initiation of such a |
| | relationship by new or previous customers. |
| Offers | Proposals by offering parties to provide value of one |
| | kind to other parties in exchange for conduct of |
| | defined kinds by the other parties. |
| Content item | A content item is any data that can be provided over |
| | a communications network. Examples of content |
| | items include: an advertisement possibly including |
| | a link to a landing page, a video file, an audio file, |
| | streaming video, streaming audio, a web form to be |
| | filled in by a user, a game, and a mobile app, among |
| | others. |

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

The logic flows depicted in the figures do not require the particular order shown, or sequential order, to achieve desirable results. In addition, other steps may be provided, or steps may be eliminated, from the described flows, and other components may be added to, or removed from, the described systems.

Other embodiments are within the scope of the following claims.

1. A computer-implemented method, the method comprising:
receiving a request associated with the presentation of an advertisement associated with an advertisement campaign to a user;
determining that the user is eligible for an offer of a reward;
sending the offer to the user, the offer defining the reward in return for the user performing an incentivized action;
receiving an indication that the user has earned the reward; and
providing the reward.

2. The method of claim 1, further comprising determining a size of the reward based on information about the user.

3. The method of claim 2, wherein the information about the user includes an indicator of the user's response to previous offers.

4. The method of claim 1, further comprising determining a size of the reward based on a comparison of a target conversion rate to a current conversion rate.

5. The method of claim 1, further comprising determining a size of the reward based on a comparison of an amount previously awarded during the advertising campaign to a remaining budget.

6. The method claim 1, further comprising determining a size of the reward based on a current time.

7. The method of claim 1, further comprising determining a size of the reward based on a number of days remaining in the advertising campaign and a budget remaining in the advertising campaign.

8. The method of claim 1, wherein receiving an indication that the user has earned the reward comprises:
receiving a code from the user; and
verifying that the code is valid.

9. The method of claim 8, wherein verifying that the code is valid comprises:
determining that an advertiser has digitally signed the code using a public key.

10. The method of claim 1, wherein the reward includes wireless network credit.

11. The method of claim 10, wherein determining that the user is eligible for the reward comprises determining that the user has an account with an operator that will provide wireless network credit.

12. The method of claim 10, wherein determining that the user is eligible for the reward comprises determining that the user does not have an unlimited wireless data plan.

13. The method of claim 10, wherein determining that the user is eligible for the reward comprises determining the remaining data usage the user has for a billing period.

14. The method of claim 10, wherein providing the reward comprises transmitting data to a remote server to cause the redemption of wireless network credit in the account by a wireless network operator server.

15. The method of claim 13, in which the wireless network credit is redeemed as a discount on the fee for an existing wireless network data plan.

16. The method of claim 1, in which credits to the user's wireless account are accumulated over time.

17. The method of claim 16, in which the credits are applied to the user's account periodically.

18. The method of claim 1, in which the user is asked to opt into the service prior to receiving an offer.

19. The method of claim 1, in which the user is asked to opt into a service prior to being determined to be eligible for an offer.

20. The method of claim 1, in which a mobile data account associated with the user's account is not charged for the presentation of the advertisement.

21. The method of claim 1, in which a credit for the data associated with the presentation of the advertisement is credited to the mobile data account associated with the user's account.

22. The method of claim 1, in which a mobile data account associated with the user's account is not charged for data used in performing the incentivized action.

23. The method of claim 1, in which a credit for the data associated with the performance of the incentivized action is credited to the mobile data account associated with the user's account.

24. The method of claim 1, in which the incentivized action includes watching a video.

25. The method of claim 1, in which the incentivized action includes filling out a survey.

26. The method of claim 1, in which the incentivized action includes providing an e-mail address.

27. The method of claim 1, in which the incentivized action includes making a purchase in a mobile application.

28. The method of claim 1, in which the incentivized action includes endorsing a product.

29. The method of claim 1, in which the incentivized action includes purchasing a good or service.

30. The method of claim 1, in which the incentivized action includes using a feature of an application.

31. The method of claim 1, in which the incentivized action includes reaching a milestone in a game.

32. The method of claim 1, in which the reward includes a gift certificate.

33. The method of claim 1, in which the reward includes a store credit.

34. The method of claim 1, in which the reward includes credit toward specific content.

35. The method of claim 1, in which the reward includes early access to content.

36. The method of claim 1, in which the reward includes access to pay per view content.

37. A computer-implemented method comprising
receiving from a user of a mobile device an indication of a response of the user to a presentation of content on the mobile device,
in connection with the presentation of the content or the receipt of the indication of a response of the user, receiving information from a mobile carrier about the user, and
based on the response of the user and the information about the user, generating an offer to be presented to the user after the content has been presented.

38. The method of claim 37 comprising receiving the information from the mobile carrier about the user between the time when the user has indicated a response to the presentation of the content and the time when the offer is presented.

39. The method of claim 37 in which the information is received from the mobile carrier about the user by sending queries to the mobile carrier and receiving replies to the queries that are based on information stored by the mobile carrier.

40. The method of claim 37 in which the indication of the response of the user to the presentation of the content is received by a party that is not the mobile carrier.

41. The method of claim 37 in which the indication of the response of the user to the presentation of the content comprises an action performed by the user in a user interface of the mobile device.

42. The method of claim 37 in which generating the offer comprises selecting an offer provided by a party who wishes to incentivize an action by the user.

43. The method of claim 37 in which generating the offer comprises selecting the offer as one that is likely to successfully incentivize an action by the user.

44. The method of claim 37 in which the offer comprises value to be provided to the user in exchange for an action of the user.

45. The method of claim 8 in which the value comprises services of a mobile carrier.

46. The method of claim 8 in which the value comprises nonmonetary rewards.

47. The method of claim 37 comprising presenting the offer to the user on an advertiser's landing page.

48. The method of claim 37 in which the offer is generated based on information about a budget of a promotional campaign associated with the offer.

49. A computer storage medium encoded with computer program instructions that when executed by one or more computers cause the one or more computers to perform operations comprising:
receiving a request associated with the presentation of an advertisement associated with an advertisement campaign to a user;
determining that the user is eligible for an offer of a reward;
sending the offer to the user, the offer defining the reward in return for the user performing an incentivized action;
receiving an indication that the user has earned the reward; and
providing the reward.

50. A system comprising:
one or more computers and one or more storage devices storing instructions that are operable, when executed by the one or more computers, to cause the one or more computers to perform operations comprising:
receiving a request associated with the presentation of an advertisement associated with an advertisement campaign to a user;
determining that the user is eligible for an offer of a reward;
sending the offer to the user, the offer defining the reward in return for the user performing an incentivized action;
receiving an indication that the user has earned the reward; and
providing the reward.

51. A computer-implemented method, the method comprising:
means for receiving a request associated with the presentation of an advertisement associated with an advertisement campaign to a user;
means for determining that the user is eligible for an offer of a reward;
means for sending the offer to the user, the offer defining the reward in return for the user performing an incentivized action;
means for receiving an indication that the user has earned the reward; and
means for providing the reward.
